(19) United States
(12) Patent Application Publication
(10) Pub. No.: US 2026/0017820 A1
(43) Pub. Date: Jan. 15, 2026

(54) Colored Point Cloud Based Refinement for Pose Estimation

(71) Applicant: The Boeing Company, Arlington, VA (US)

(72) Inventors: Fan Hin Hung, Los Angeles, CA (US); Deepak Khosla, Camarillo, CA (US); Leon Nguyen, Santa Ana, CA (US); Shawn M. Chamberlain, Federal Way, WA (US); Tameez Latib, Los Angeles, CA (US); Neale James Ratzlaff, Canoga Park, CA (US)

(21) Appl. No.: 18/768,862

(22) Filed: Jul. 10, 2024

(51) Int. Cl. G06T 7/73; G06T 7/90

(52) U.S. Cl. CPC G06T 7/74; G06T 7/90; G06T 2207/10016; G06T 2207/10028

(57) ABSTRACT

A pose estimation system comprising a computer system and a pose estimator. The pose estimator is configured to estimate initial point cloud colors for points in a colored point cloud of a surface of an object using frames in a video of the object and initial pose estimates for the object in the frames; adjust the initial pose estimates using the frames and the colored point cloud to form updated pose estimates; and determine updated point cloud colors for the points in the colored point cloud using the frames in the video and the updated pose estimates. The pose estimator is configured to repeat adjusting the updated pose estimates using the frames and the colored point cloud and determining the updated point cloud colors for the points using the frames in the video and the updated pose estimates until the updated pose estimates meet a threshold.

### BACKGROUND INFORMATION

### 1. Field

The present disclosure relates generally to refueling aircraft and in particular, to pose estimation for training a machine learning model for controlling aircraft refueling operations.

### 2. Background

With air-to-air refueling a six degree of freedom (6DoF) position and orientation is estimated for a receiver aircraft following behind a fuel tanker aircraft. The position and orientation is referred to as a pose. The fuel tanker aircraft is equipped with a refueling boom that has an end that can be maneuvered to be inserted into a receptacle in the receiver aircraft to begin a refueling operation.

For example, a camera on the fuel tanker aircraft can generate images of the boom and receiver aircraft. A machine learning model can perform real time 6DoF pose estimation as part of a process to control the refueling operation using the boom.

### SUMMARY

An embodiment of the present disclosure provides a computer implemented method for pose estimation. A number of processor units estimate initial point cloud colors for points in a colored point cloud of a surface of an object using frames in a video of the object and initial pose estimates for the object in the frames. The number of processor units adjust the initial pose estimates to form updated pose estimates using the frames and the colored point cloud. The number of processor units determine updated point cloud colors for the points in the colored point cloud using the frames in the video and the updated pose estimates. The number of processor units repeat adjusting the updated pose estimates using the frames and the colored point cloud and determining the updated point cloud colors for the points in the colored point cloud using the frames in the video and the updated pose estimates until the updated pose estimates meet a threshold.

Another embodiment of the present disclosure provides a pose estimation system comprising a computer system and a pose estimator located in the computer system. The pose estimator is configured to estimate initial point cloud colors for points in a colored point cloud of a surface of an object using frames in a video of the object and initial pose estimates for the object in the frames. The pose estimator is configured to adjust the initial pose estimates using the frames and the colored point cloud to form updated pose estimates. The pose estimator is configured to determine updated point cloud colors for the points in the colored point cloud using the frames in the video and the updated pose estimates. The pose estimator is configured to repeat adjusting the updated pose estimates using the frames and the colored point cloud and determining the updated point cloud colors for the points in the colored point cloud using the frames in the video and the updated pose estimates until the updated pose estimates meet a threshold.

Still another embodiment of the present disclosure provides a computer program product for pose estimation. The computer program product comprises a set of one or more computer-readable storage media and program instructions, collectively stored in the set of one or more storage media. The program instructions cause a processor set to perform computer operations comprising estimate initial point cloud colors for points in a colored point cloud of a surface of an object using frames in a video of the object and initial pose estimates for the object in the frames; adjust the initial pose estimates using the frames and the colored point cloud to form updated pose estimates; determine updated point cloud colors for the points in the colored point cloud using the frames in the video and the updated pose estimates; and repeat adjusting the updated pose estimates using the frames and the colored point cloud and determining the updated point cloud colors for the points in the colored point cloud using the frames in the video and the updated pose estimates until the updated pose estimates meet a threshold.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a pose estimation for a receiver aircraft in accordance with an illustrative embodiment;

FIG. 2 is an illustration of a block diagram of a pose environment in accordance with an illustrative embodiment;

FIG. 3 is an illustration of a use of pose estimates in accordance with an illustrative embodiment;

FIG. 4 is an illustration of a frame and a colored point cloud in accordance with an illustrative embodiment;

FIG. 5 is an illustration of estimating colors for a colored point cloud in accordance with an illustrative embodiment;

FIG. 6 is an illustration of refining pose estimates in accordance with an illustrative embodiment;

FIG. 7 is an illustration of iteratively performing color estimation and pose estimation to refine pose estimates for frames in a video in accordance with an illustrative embodiment;

FIG. 8 is an illustration of a flowchart of a process for this estimation in accordance with an illustrative embodiment;

FIG. 9 is an illustration of a flowchart of a process for estimating point cloud colors in accordance with an illustrative embodiment;

FIG. 10 is an illustration of a flowchart of a process for taking into account an occluder of the object in accordance with an illustrative embodiment;

FIG. 11 is an illustration of a flowchart of a process for estimating the point cloud colors in accordance with an illustrative embodiment;

FIG. 12 is an illustration of a flowchart of a process for adjusting pose estimates in accordance with an illustrative embodiment;

FIG. 13 is an illustration of a flowchart of a process for training a machine learning model using the pose estimates in accordance with an illustrative embodiment; and

FIG. 14 is an illustration of a block diagram of a data processing system in accordance with an illustrative embodiment.

### DETAILED DESCRIPTION

The illustrative embodiments recognize and take into account one or more different considerations as described herein. For example, obtaining the actual ground truth 6DoF pose of a receiver aircraft in real-world data is more difficult than desired for training a machine learning model to estimate the pose of the receiver aircraft for use in controlling the refueling operation.

Global positioning system (GPS) data generally does not offer a level of fidelity required for air-to-air refueling. Data from other sensors such as external lidars or inertial measurement units (IMUs) are difficult to synchronize temporally with camera frame timing and geometrically with the camera's mounting angle to a desired level of precision for this type of refueling operation involving a tanker aircraft and a receiver aircraft.

With these issues, training a machine learning model to generate a pose estimation for a receiver aircraft can be more difficult than desired because of the challenges in obtaining accurate pose estimates for a receiver aircraft in a video.

Thus, the illustrative examples provide a computer implemented method, apparatus, system, and computer program product for pose estimation. In one illustrative example, pose estimation system comprising a computer system and a pose estimator located in the computer system. The pose estimator is configured to estimate initial point cloud colors for points in a colored point cloud of a surface of an object using frames in a video of the object and initial pose estimates for the object in the frames. The pose estimator is configured to adjust the initial pose estimates using the frames and the colored point cloud to form updated pose estimates. The pose estimator is configured to determine updated point cloud colors for the points in the colored point cloud using the frames in the video and the updated pose estimates. The pose estimator is configured to repeat adjusting the updated pose estimates using the frames and the colored point cloud and determining the updated point cloud colors for the points in the colored point cloud using the frames in the video and the updated pose estimates until the updated pose estimates meet a threshold.

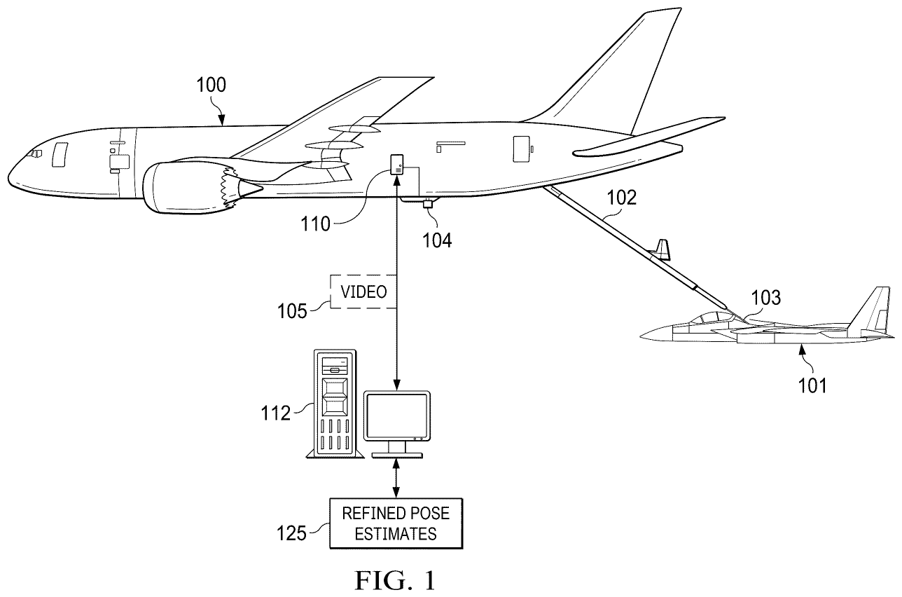

With reference now to the figures and, in particular, with reference to FIG. 1, an illustration of pose estimation for a receiver aircraft is depicted in accordance with an illustrative embodiment. In this illustrative example, an air-to-air refueling operation between fueling tanker aircraft 100 and receiver aircraft 101 is shown. As depicted in this example, receiver aircraft 101 is following behind fueling tanker aircraft 100. Fueling tanker aircraft 100 is equipped with boom 102, which is coupled to receptacle 103 of receiver aircraft 101 for the refueling operation.

In this illustrative example, boom 102 is guided to receptacle 103 and receiver aircraft 101 using images in camera imagery and video data generated by camera system 104. In this example, the camera imagery comprises images captured by camera system 104. The video data has metadata such as timestamps and GPS information. This information forms video 105.

During normal operation of tanker aircraft 100, this video can be used by image processing algorithms and models in computer 110 to determine a pose estimate for receiver aircraft 101. In these illustrative examples, this pose estimate is a 6 degree of freedom (6DoF) pose estimate of the receiver aircraft 101.

This pose estimate can be used by an automated controller in computer 110 to guide boom 102 into receptacle 103 of receiver aircraft 101.

In these illustrative examples, video 105 is also sent to computer 112 for processing to generate refined pose estimates 125 for receiver aircraft 101. This refining of the pose estimate can be a postprocessing operation performed after the refueling of receiver aircraft 101.

In one illustrative example, refined pose estimates 125 can be used with video 105 to train a machine learning model to more accurately determine the pose estimate for a receiver aircraft. In another illustrative example, refined pose estimates 125 can be used to determine the accuracy of pose estimates generated by computer 110. Those pose estimates can be compared to refined pose estimates 125 to determine the accuracy of current processes or models used in computer 110 for generating pose estimates used by a controller to guide boom 102 to perform air-to-air refueling operations.

Thus, in these illustrative examples, refined pose estimates 125 are pose estimates with increased accuracy when obtaining ground truth pose data for real-world videos is difficult. Refined pose estimates 125 provide a next best alternative to using absolute ground truth pose data.

The illustration of pose estimates used for air-to-air refueling operations is provided as one example of a use for refined pose estimates 125. This illustration is not meant to limit the manner in which other illustrative examples can be implemented. In another illustrative example, video 105 can be a video of the assembly of a part performed by a robot. Refined pose estimates 125 can be generated for training a machine learning model to control the robot to perform the part assembly with increased accuracy. Still another example, can be a part assembly system.

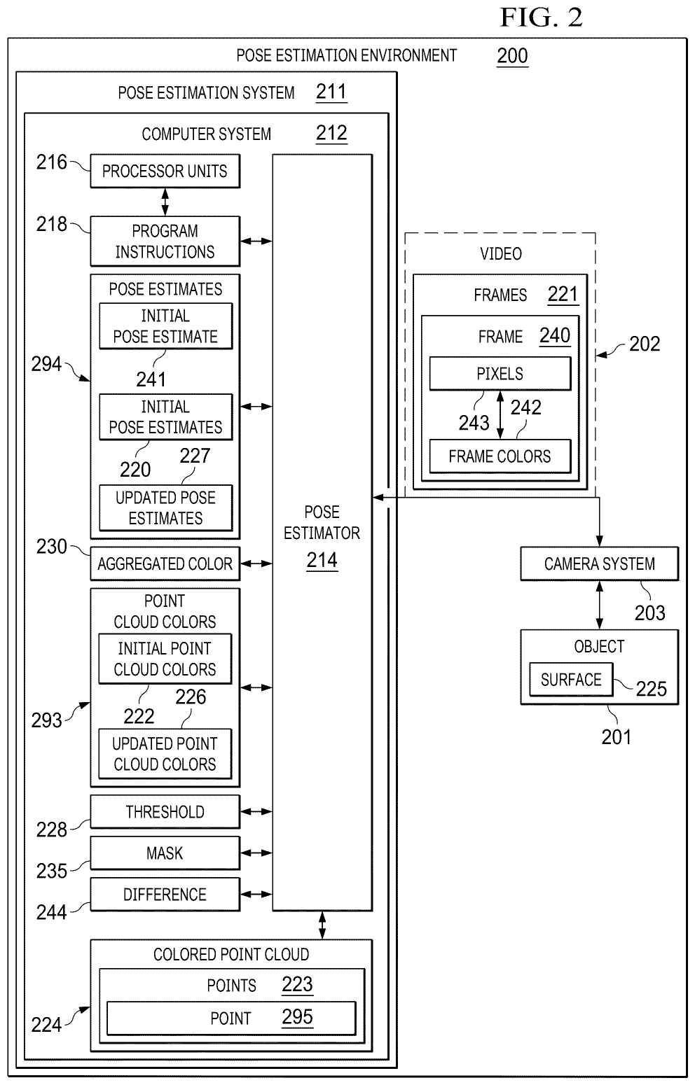

With reference now to FIG. 2, an illustration of a block diagram of a pose environment is depicted in accordance with an illustrative embodiment. In this illustrative example, pose estimation environment 200 includes components that can be implemented in hardware such as the hardware shown in fueling tanker aircraft 100 in FIG. 1.

In this illustrative example, pose estimation system 211 can estimate poses for object 201 using video 202 generated by camera system 203. Object 201 can be selected from a group comprising a mobile platform, a stationary platform, a land-based structure, an aquatic-based structure, a space-based structure, an aircraft, a receiver aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, a building, and other types of platforms.

As depicted, pose estimation system 211 comprises computer system 212 and pose estimator 214. Pose estimator 214 is located in computer system 212.

Pose estimator 214 can be implemented in software, hardware, firmware or a combination thereof. When software is used, the operations performed by pose estimator 214 can be implemented in program instructions configured to run on hardware, such as a processor unit. When firmware is used, the operations performed by pose estimator 214 can be implemented in program instructions and data and stored in persistent memory to run on a processor unit. When hardware is employed, the hardware can include circuits that operate to perform the operations in pose estimator 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, pose estimator 214 performs a number of different operations to refine pose estimates 220 for frames 221 in video 202. A pose estimate is a position and an orientation for object 201. The position can be described by three-dimensional coordinates. The orientation can be described using roll, pitch, and yaw. In this manner, a pose estimate can have 6 degrees of freedom.

For example, pose estimator 214 estimates initial point colors 222 in point cloud colors 293 for points 223 in colored point cloud 224 of surface 225 of object 201 using frames 221 in video 202 of object 201 and initial pose estimates 220 in pose estimates 294 for object 201 in frames 221. In this example, colored point cloud 224 is a three-dimensional point cloud in which points 223 are located in positions in three-dimensional space.

In this illustrative example, a frame in frames 221 is a two-dimensional array of pixels that captures visual information about a scene as captured by camera system 203. Each point in the frame corresponds to a specific point in the scene and includes color intensity values to form an image. The frame can also be referred to as the image frame. A pose estimate can the different for object 201 in different frames resulting movement of object 201 within a frame.

In this example, pose estimator 214 adjusts initial pose estimates 220 using frames 221 and colored point cloud 224. Colored point cloud 224 includes estimates of initial point cloud colors 222 for points 223 when used to adjust initial pose estimates 220 using frames 221.

Further, pose estimator 214 determines updated point cloud colors 226 for points 223 in colored point cloud 224 using frames 221 in video 202 and initial pose estimates 220 with adjustments. These initial pose estimates with adjustments are updated pose estimates 227. In this example, pose estimator 214 repeats adjusting updated pose estimates 227 and determining updated point cloud colors 226 until update pose estimates 227 meet threshold 228.

Threshold 228 can take a number of different forms. For example, threshold 228 can be an amount of error between colors in colored point cloud 224 and the colors identified for pixels corresponding to points 223 in frames 221.

In determining these colors, points 223 are three-dimensional points that can be mapped to two-dimensional points in each of frames 221. This mapping can also be referred to as projecting points 223 onto frames 221. In another example, threshold 228 can be how much updated pose estimates 227 change from prior pose estimates. Once adjustments to updated pose estimates 227 are complete, these updated pose estimates are an example of refined pose estimates 125 in FIG. 1.

In one example, pose estimator 214 can estimate initial point cloud colors 222 by projecting colored point cloud 224 onto frame 240 in frames 221 using initial pose estimate 241 in pose estimates 220 for object 201 in frame 240. In this example, projecting means mapping points 223 in colored point cloud 224 onto pixels 243 in frame 240 based on the perspective projection of camera system 203. In other words, pose estimator 214 performs this projection by rendering colored point cloud 224 into a two-dimensional rendered view.

In this example, not every point in colored point cloud 224 may be mapped to a pixel in frame 240. For example, some points in points 223 may represent a portion of surface 225 that is not visible within frame 240. This mapping can be performed for each frame in frames 221.

For example, the coordinates of points 223 for surface 225 of object 201 are changed from the coordinate system of colored point cloud 224 to a camera coordinate system for camera system 203. With this change in the coordinate system, points 223 in colored point cloud 224 can be mapped into corresponding pixels in a frame. The pixels values for the pixels in frame 240 describe color by properties such as intensity and hue. This mapping can then be used to assign colors from pixels 243 in frame 240 to points 223 in colored point cloud 224 that map to pixels 243.

In this example, a pose estimate is a pose estimate for object 201 in the particular frame being processed. In other words, each frame has a pose estimate for object 201 that is visible within the frame.

Pose estimator 214 estimates initial point cloud colors 222 for points 223 in colored point cloud 224 using pixel values for pixels in the frame. Pose estimator 214 repeats projecting and determining for each frame in frames 221. Thus, initial point cloud colors 222 are determined for each point in colored point cloud 224. In other words, each point can have multiple colors based on the colors determined from the corresponding points in the different frames in frames 221.

Pose estimator 214 determines aggregated color 230 for each point in the colored point cloud using the point cloud colors for the points determined from the frames. This aggregation of colors can be formed in a number of different ways. For example, aggregated color 230 for point 295 in points 223 can be a statistical measure across the frames selected from at least one of a mean, a median, a weighted average of the point cloud colors determined for the point, or other statistical measure.

In another illustrative example, pose estimator 214 can create mask 235 identifying pixels in the frame for an occluder that blocks a view of a portion of object 201 in frame 240. Pose estimator 214 determines colors without the pixel values that are within mask 235. With mask 235, initial point cloud colors 222 can be estimated for points 223 that do not use points in frames 221 that are secured by objects such as a boom when video 202 is a video of object 201 in the form of a receiver aircraft in air-to-air refueling operations in which a boom is present and blocks or obscures the view of a portion of object 201 in frames 221 in video 202. The mask can be generated for each frame based on the position of the boom or other object occluding object 201.

In still another illustrative example, pose estimator 214 can estimate initial point cloud colors 222 by projecting colored point cloud 224 onto frame 240 using pose estimate 241 for object 201. Pose estimator 214 determines initial point cloud colors 222 for points 223 in colored point cloud 224 using pixel values for pixels 243 in frame 240.

In this example, only one pose estimate is used with a frame. This can be the first frame or some other frame in frames 221. With this example, the process forms a pose estimate frame by frame to obtain a set of coarse pose estimates for the different frames in the video from initial point cloud colors 222 generated for points 223 in colored point cloud 224. In this example, multiple colors are not identified for different poses in different frames in frames 221.

In this illustrative example, pose estimator 214 can adjust a pose estimate by projecting colored point cloud 224 onto frame 240 in frames 221 using initial pose estimate 241 in initial pose estimates 227 for object 201 in frame 240. Pose estimator 214 determines difference 244 between frame colors 242 for pixels 243 in frame 240 and initial point cloud colors 222 for points 223 in colored point cloud 224 corresponding to pixels 243 in frame 240.

Next, pose estimator 214 adjusts initial pose estimate 241 using difference 244. The adjustments are made to reduce difference 244 between frame colors 242 in frame 240 and initial point cloud colors 222 in colored point cloud 224 that correspond to pixels 243. This adjustment of initial pose estimate 241 results in an updated pose estimate.

Initial pose estimate 241 for object 201 in frame 240 can be adjusted by optimizing an objective function. In this example, the objective function can be a mathematical model using parameters such as the pose estimates to compute difference 244 between initial point cloud colors 222 and frame colors 242. This objective function can reduce error by systematically adjusting parameters such as the pose estimates to reduce difference 244 between initial point cloud colors 222 and frame colors 242. This process can be repeated until at least one of updated pose estimates 227 or difference 244 meets threshold 228. Threshold 228 can be met, for example, when changes to pose estimates 220 no longer occur or change by an amount that is within threshold 228. Pose estimator 214 performs this process for each frame in frames 221 to form updated pose estimates 227 for frames 221.

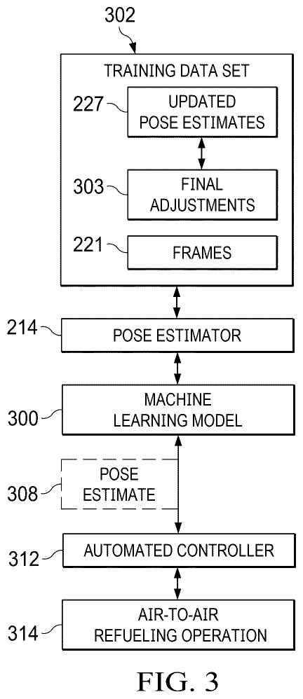

With reference next to FIG. 3, an illustration of a use of pose estimates is depicted in accordance with an illustrative embodiment. In the illustrative examples, the same reference numeral may be used in more than one figure. This reuse of a reference numeral in different figures represents the same element in the different figures.

In this example, a practical application of updated pose estimates 227 is depicted in which updated pose estimates 227 are used to train machine learning model 300. In this example, object 201 takes the form of a receiver aircraft. Frames 221 are from a video of an air-to-air refueling operation with the receiver aircraft.

In this example, pose estimator 214 creates training dataset 302 that comprises frames 221 and the updated pose estimates 227 with final adjustments 303 for frames 221. In this example, final adjustments 303 are adjustments to updated pose estimates 227 that have been completed. In this example, the accuracy is at a desired level using threshold 228.

In this example, pose estimator 214 trains machine learning model 300 using training dataset 302. With this training, machine learning model 300 determines pose estimate 308 of the receiver aircraft in response to receiving a live video of the receiver aircraft following a tanker aircraft. With this example, automated controller 312 can receive pose estimate 308 and use pose estimate 308 to control an air-to-air refueling operation 314 in which a refueling boom is guided to a receptacle in the receiver aircraft. In this example, automated controller 312 can be at least one of hardware or software running on a computer in a tanker aircraft. Machine learning model 300 in its trained form can also be located on the tanker aircraft. These two components can operate to perform air-to-air refueling operation 314.

In one illustrative example, one or more solutions are present that overcome a problem with attaining pose with a sufficient level of accuracy for various automated operations. As a result, one or more solutions can provide an effect generating pose estimates for use in training machine learning models. Further, these pose estimates can also be used to determine the accuracy of machine learning models that estimate poses. The pose estimation in the different illustrative examples provide a higher level of accuracy as compared to current techniques using global positioning systems, inertial measurement units, and other types of devices. This type of pose estimation is useful when ground truth information is unavailable or harder to obtain for frames indicated.

Computer system 212 can be configured to perform at least one of the steps, operations, or actions described in the different illustrative examples using software, hardware, firmware or a combination thereof. As a result, computer system 212 operates as a special purpose computer system in which pose estimator 214 in computer system 212 enables determining pose estimates of an object in frames in a video.

In the illustrative example, the use of pose estimator 214 in computer system 212 integrates processes into a practical application for training machine learning model 300 to generate pose estimates that can be used to perform various operations.

Thus, pose estimator 214 can generate refined pose estimates that have a greater accuracy than currently available when using other sources of information such as global positioning satellite (GPS). The use of data to obtain ground truth poses can be fairly difficult. For example, the data from external lidars or inertial measurement units (IMUs) are difficult to synchronize temporally with camera frame timing. The use of manual labeling to obtain ground truth poses can be tedious and subjective.

The illustration of pose estimation environment 200 in the different components in FIG. 2-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, the pose estimates in FIG. 3 can be generated for other objects other than a receiver aircraft. In another example, pose estimates can be generated for use in training a machine learning model to control a robot to assemble parts. In another illustrative example, pose estimates can be generated for composite materials that are being laid up to manufacture composite parts. These pose estimates can be used to control robotic arms, gantries, end effectors, and other equipment to automatically manufacture composite parts.

In yet another illustrative example, one or more objects can be present in addition to object 201 in frames 221 and video 202. With this example, pose estimates can be generated for the other objects in addition to object 201. In yet another example, the threshold for stopping refinements of pose estimates 220 can be based on a number of iterations rather than difference 244 between colors.

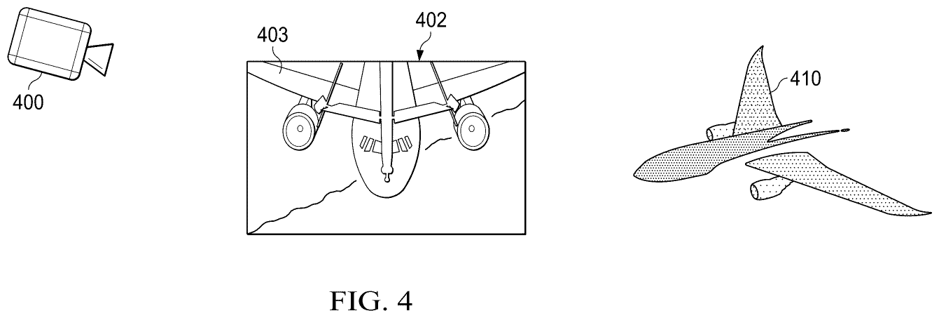

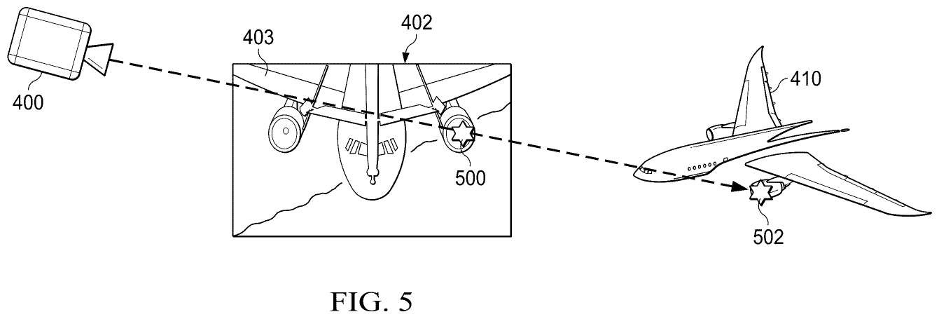

In FIGS. 4 and 5 illustrate estimating colors for three-dimensional point clouds is depicted in accordance with an illustrative embodiment. The process described in these figures can be implemented by pose estimator 214 in FIG. 2.

With reference first to FIG. 4, an illustration of a frame and a colored point cloud is depicted in accordance with an illustrative embodiment. In this illustrative example, camera 400 generates frame 402. Receiver aircraft 403 is shown in frame 402.

Colored point cloud 410 is a visualization of coordinates and color information for a colored point cloud such as colored point cloud 224 in FIG. 2. In this example, the different points in this point cloud represent the surface of receiver aircraft 403. Further, this point cloud has a pose estimate for receiver aircraft 403 in frame 402. This is an initial pose that will be refined. This initial pose can be obtained, for example, by using a machine learning model to estimate points on receiver aircraft 403 in frame 402 that correspond to points on a three-dimensional representation of the receiver aircraft, such as colored point cloud 410, and then using an algorithm to solve for the pose estimate based on this point correspondence, such as the Perspective n-Point (PnP) algorithm.

In this example, the estimating of colors for colored point cloud 410 can be performed using frame 402, camera specifications for camera 400, and a pose estimate for receiver aircraft 403 and frame 402.

With this information, three-dimensional points in colored point cloud 410 can be mapped to pixel values using calculations from currently available three-dimensional rendering techniques. These techniques can be selected from at least one of perspective projection, orthographic projection, ray tracing, rasterization, or other suitable techniques.

For example, the pose estimate is used to move the three-dimensional point cloud coordinates for colored point cloud 410 into the frame of reference for camera 400 in a position corresponding to the location of receiver aircraft 403 in frame 402. For example, the orientation parameters of the pose estimate can form a rotation matrix in three-dimensional space, and the position parameters of the pose estimate can form a vector in the same three-dimensional space. Then, if the pose estimate relates points from the colored point cloud frame of reference to the location of the receiver aircraft with respect to the camera frame of reference, then any point in colored point cloud 410 can be mapped to a point relative to camera 400 in a position consistent with the location of receiver aircraft 403 by applying the rotation matrix to the point and then adding the vector to the result. In this example, the coordinate system for colored point cloud 410 is rotated and translated into the coordinate system for camera 400. These three-dimensional point cloud coordinates are used to describe the position of points in colored point cloud 410.

Turning next to FIG. 5, an illustration of estimating colors for a colored point cloud is depicted in accordance with an illustrative embodiment. In this example, camera specifications for camera 400 can be used to project the three-dimensional coordinates to the two-dimensional coordinate space of frame 402. These specifications for camera 400 can include at least one of focal length, principal point, skew, field of view, distortion parameters, image resolution, or other specifications.

With these camera specifications, a camera matrix can be constructed to perform perspective projection of three-dimensional coordinates to the two-dimensional coordinate space of frame 402. Furthermore, if distortion parameters are known, then the resulting two-dimensional coordinates can be further transformed within the same two-dimensional coordinate space through a distortion model that describes optical aberrations consistent with the optical elements for camera 400, such as barrel distortion or pincushion distortion.

In this depicted example, the two-dimensional coordinates can be used to reference pixels in frame 402 and retrieve color values to assign to each of points in colored point cloud 410 that map to the pixels in frame 402. For example, the pixel information from pixel 500 can be used to assign a color to corresponding point 502 in colored point cloud 410. In this example, corresponding point 502 maps to pixel 500.

The processes described in FIG. 4 and FIG. 5 can be performed for each frame in the frames of a video. Each frame has a pose that is used to determine colors for colored point cloud 410. As a result, colored point cloud 410 can have multiple color values for each point in the point cloud. The color values for each point can be aggregated to obtain the color for the points in colored point cloud 410.

The aggregation can be performed in a number of different ways. For example, the aggregation of the colors for a point can be performed by using at least one of a mean, a median, or a weighted average or other technique to aggregate the colors determined for the point.

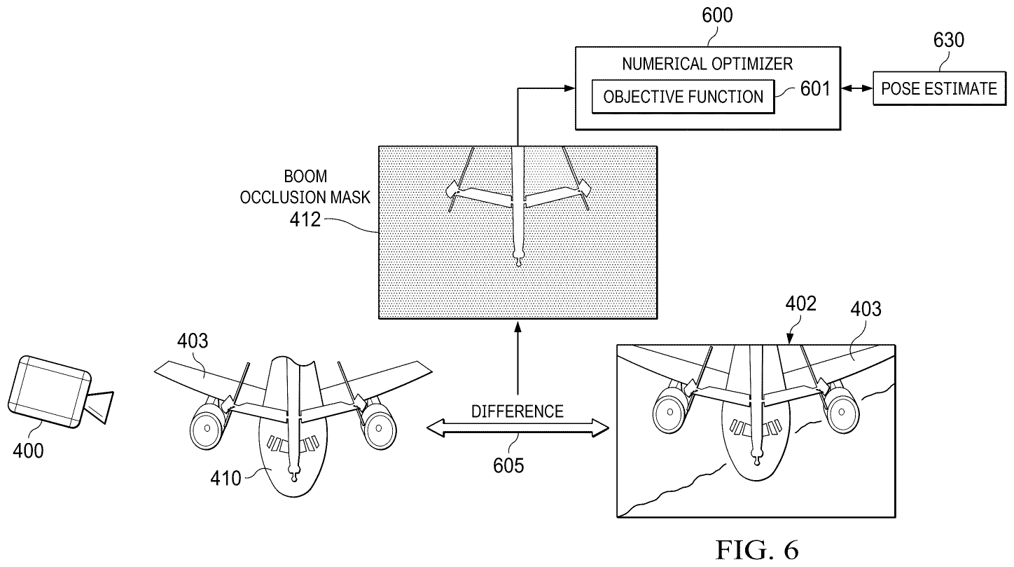

Turning now to FIG. 6, an illustration of refining pose estimates is depicted in accordance with an illustrative embodiment. The process in this example can be implemented in pose estimator 214 in FIG. 2.

The process depicted in this figure uses numerical optimizer 600 to adjust the pose estimate for frame 402. This adjustment can be performed such that the pixel colors of receiver aircraft 403 in frame 402 match or more closely match the colors for corresponding points in colored point cloud 410 that are mapped to these pixels in frame 402. Adjusting the pose estimate and determining the difference 605 are performed iteratively in this example and increase the accuracy of the pose estimate for receiver aircraft 403 in frame 402.

In this illustrative example, objective function 601 is implemented in numerical optimizer 600. Numerical optimizers search for an optimal set of parameters based on reducing an objective function by evaluating the objective function with varying sets of parameters. The objective function can also be referred to as, also known as a loss function, a cost function, or an energy function. Numerical optimizers include techniques such as Newton's method, conjugate gradient, Nelder-Mead, or other techniques.

In this example, the optimizer searches for an optimal set of 6DoF pose parameters to minimize the objective function, which is a function over the 6DoF pose parameters that indicates the degree of error in difference 605.

In this depicted example, objective function 601 uses camera specifications for camera 400, frame 402, and colored point cloud 410 as fixed constants. Objective function 601 uses the pose estimate for frame 402 as an input variable and uses this pose estimate with the fixed constants to calculate the amount by which the two-dimensional rendered view of colored point cloud 410 differs from the two-dimensional view of receiver aircraft 403 in frame 402. This amount is difference 605 and is an example of difference 244 in FIG. 2 and can also be referred to as an error.

In this illustrative example, objective function 601 uses the pose estimate for receiver aircraft 403 and frame 402 to move the three-dimensional point cloud coordinates for colored point cloud 410 into the camera's frame of reference in a position corresponding to the location of receiver aircraft 403 in frame 402. In other words, the coordinate system for colored point cloud 410 is translated into the coordinate system for camera 400.

Next, the three-dimensional coordinates of the points in colored point cloud 410 are projected to the two-dimensional coordinate space of frame 402 using the camera specifications. These camera specifications include, for example, focal length and image resolution. This projection maps three-dimensional points in colored point cloud 410 to two-dimensional pixels in frame 402.

The two-dimensional coordinates for the points can be used to reference pixels in frame 402 and retrieve color values for each of points in the colored point cloud 410 that have been mapped to pixels in frame 402.

In this example, there are two sets of color values for colored point cloud 410. One set of colors is from the previous aggregate color determination using the frames in the video. The other set of colors are colors obtained from mapping colored point cloud 410 to the two-dimensional image in frame 402 using the pose estimate for receiver aircraft 403 in frame 402.

In this example, objective function 601 performs a color error calculation for the pose estimate. For example, objective function 601 calculates the Euclidean distance for each point's two colors and averages the distances for all points in colored point cloud 410. The final average value represents difference 605 in color between the mapping of the post estimate to frame 402, and the point cloud color from aggregating the colors as described in FIG. 4 and FIG. 5.

Numerical optimizer 600 uses objective function 601 to adjust pose estimate 630 in an effort to reduce difference 605. The color error calculation is performed for the adjusted pose. To refine pose estimate 630 for frame 402, numerical optimizer 600 is an iterative process to minimize objective function 601.

At each iteration, the numerical optimizer 600 calculates objective function 601 and determines an adjustment to pose estimate 630. This adjustment to pose estimate 630 tries to decrease the color difference between the new color values from projecting receiver aircraft 403 onto frame 402 based on pose estimate 630 and the point cloud colors from an aggregation of colors from the frames.

This refinement of pose estimate 630 for receiver aircraft 403 in frame 402 can be repeated until difference 605 between the colors reaches a threshold. For example, numerical optimizer 600 stops when difference 605 reaches a threshold such as a pre-determined iteration limit or a pre-determined threshold for convergence.

In this illustrative example, receiver aircraft 403 in frame 402 is for an air-to-air refueling operation. With this type of application, a masking operation can be used to account for occlusion by the refueling boom. This masking is performed using pose information for the refueling boom. This pose information can be derived from known boom control parameters, sensor readings, or an estimation pipeline.

In this example, the boom pose estimate and camera specifications for camera 400 are used to render a binary mask such as boom occlusion mask 412. This mask indicates which pixels in frame 402 are occupied by the boom. With this example, boom occlusion mask 412 is used to exclude points in colored point cloud 410 whose two-dimensional projections fall within pixels occupied by the boom.

This process using boom occlusion mask 412 is performed before objective function 601 compares the two sets of point cloud colors. As a result, colors from the boom are not included in the difference calculation.

In this example, calculating objective function 601 at the ground truth pose with the ground truth point cloud coloring results in a value of zero. In other words, the difference 605 between the colors on colored point cloud 410 and the colors from projecting receiver aircraft 403 on frame 402 is zero. This value is what numerical optimizer 600 is trying to reach when calculating objective function 601.

However, this ideal value can only be reached with ground truth pose and ground truth point cloud coloring. In this example, numerical optimizer 600 searches for a value that is as close as possible to the ideal value. The use of objective function 601 makes the assumption that the initial pose estimate from live runtime is within a local region in pose parameter space to the ground truth pose. This assumption makes the numerical optimization a theoretically well-posed problem where it is tractable to obtain an adjusted pose estimate that is closer to the ground truth pose.

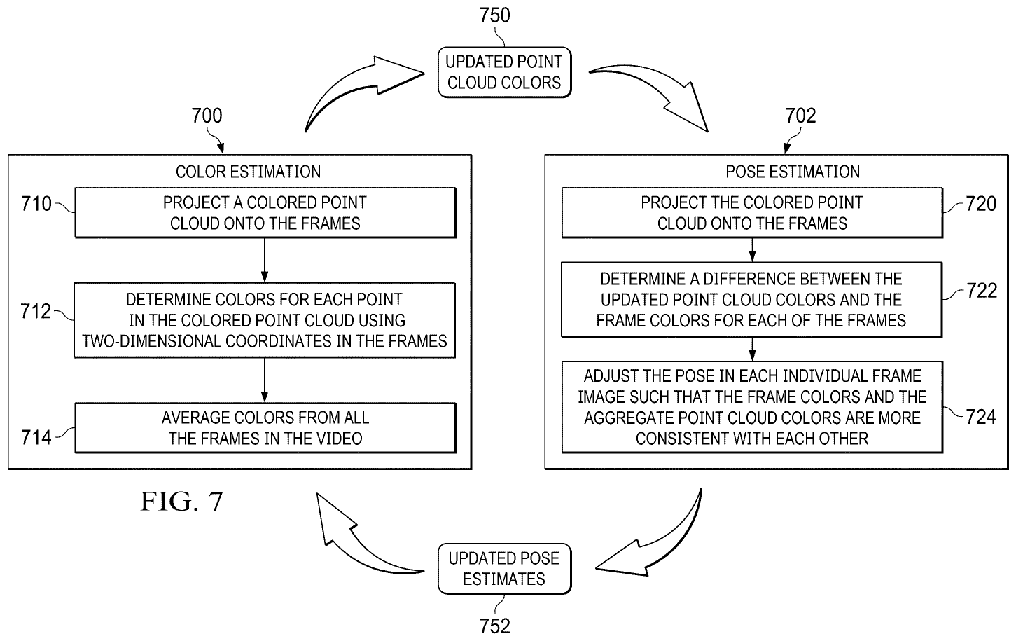

Turning next to FIG. 7, an illustration of iteratively performing color estimation and pose estimation to refine pose estimates for frames in a video is depicted in accordance with an illustrative embodiment. This dataflow can be implemented in pose estimator 214 in FIG. 2.

In this example, the dataflow implements color estimation 700 and pose estimation 702. These blocks iteratively perform operations to refine pose estimates for frames in a video.

As depicted, color estimation 700 projects a colored point cloud onto the frames (operation 710). The projection correlates points in the colored point cloud to pixels in the frames using the pose estimates for the frames.

Color estimation 700 determines colors for each point in the colored point cloud using two-dimensional coordinates in the frames (operation 712). In operation 712, points in the colored point cloud are mapped to pixels in the frames. Not all of the points are mapped to the pixels in each frame. The pixel values of the pixels are used to assign colors to the points mapped to pixels in the frames using the two-dimensional coordinates in the frames determined for the points. Each point can have multiple colors if multiple frames are present.

Color estimation 700 averages colors from all the frames in the video (operation 714). In operation 714, the colors for each point are averaged to determine an updated color for the point. Thus, color estimation 700 aggregates colors for individual pose estimates throughout frames in the video. The result is represented as updated point cloud colors 750 in a colored point cloud. These updated point cloud colors are an aggregation of point cloud colors generated for each of the points in the colored point cloud.

Updated point cloud colors 750 are used by pose estimation 702 to generate refined pose estimates that are updated pose estimates 752. In this example, pose estimation 702 projects the colored point cloud onto the frames (operation 720). Pose estimation 702 determines a difference between the updated point cloud colors 750 and the frame colors for each of the frames (operation 722).

In this example, pose estimation 702 adjusts the pose in each individual frame image such that the frame colors and the aggregate point cloud colors are more consistent with each other (operation 724). These adjustments form updated pose estimates 752.

The pose estimates with the updates form updated post estimates 752. These updated pose estimates are used in color estimation 700 to determine aggregate colors for the colored point cloud. The process can be repeated using updated pose estimates 752. Each loop through the feedback cycle enforces greater frame to frame color consistency.

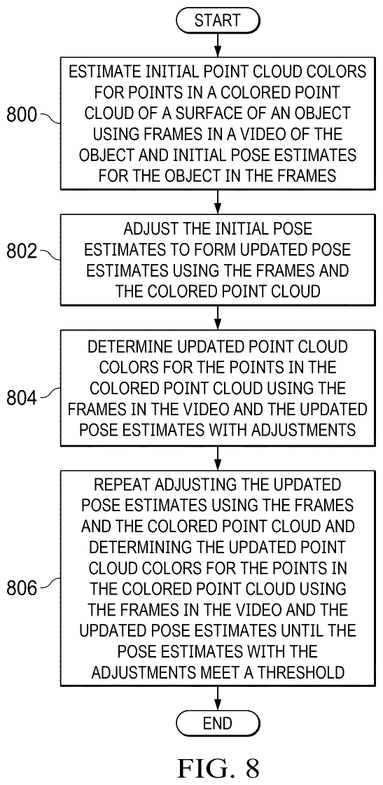

Turning next to FIG. 8, an illustration of a flowchart of a process for this estimation is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in pose estimator 214 in computer system 212 in FIG. 2.

The process estimates initial point cloud colors for points in a colored point cloud of a surface of an object using frames in a video of the object and initial pose estimates for the object in the frames (operation 800). The process adjusts the initial pose estimates to form updated pose estimates using the frames and the colored point cloud (operation 802). The process determines updated point cloud colors for the points in the colored point cloud using the frames in the video and the updates pose estimates with adjustments (operation 804).

The process repeats adjusting the updated pose estimates using the frames and the colored point cloud and determining the updated point cloud colors for the points in the colored point cloud using the frames in the video and the updated pose estimates until the pose estimates with the adjustments meet a threshold (operation 806). The process terminates thereafter.

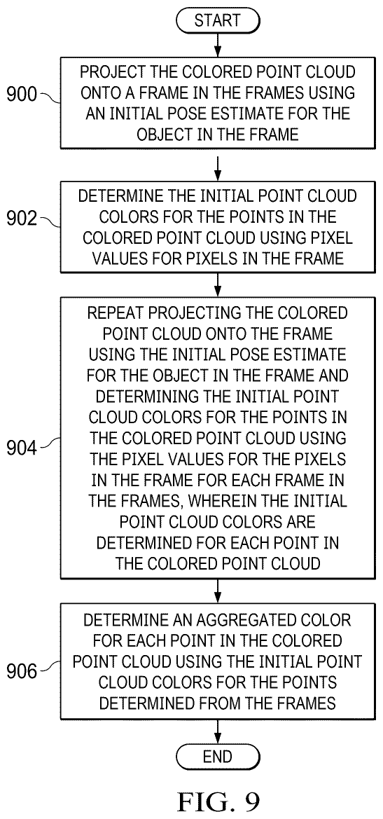

With reference now to FIG. 9, an illustration of a flowchart of a process for estimating point cloud colors is depicted in accordance with an illustrative embodiment. The process in this figure is an example of an implementation for operation 800 in FIG. 8.

The process projects the colored point cloud onto a frame in the frames using an initial pose estimate for the object in the frame (operation 900). This pose estimate is for the frame. In other words, the pose estimate is for the pose of the object in the frame. The process determines the initial point cloud colors for the points in the colored point cloud using pixel values for pixels in the frame (operation 902). The process repeats projecting the colored point cloud onto the frame using the initial pose estimate for the object in the frame and determining the initial point cloud colors for the points in the colored point cloud using the pixel values for the pixels in the frame for each frame in the frames, wherein the initial point cloud colors are determined for each point in the colored point cloud (operation 904).

The process determines an aggregated color for each point in the colored point cloud using the initial point cloud colors for the points determined from the frames (operation 906). The process terminates thereafter. In operation 906, the aggregated color for a point is a statistical measure across the frames. In this example, aggregated color 230 for a point can be a statistical measure selected from at least one of a mean, a median, or a weighted average of the point cloud colors determined for the point, or some other statistical measure.

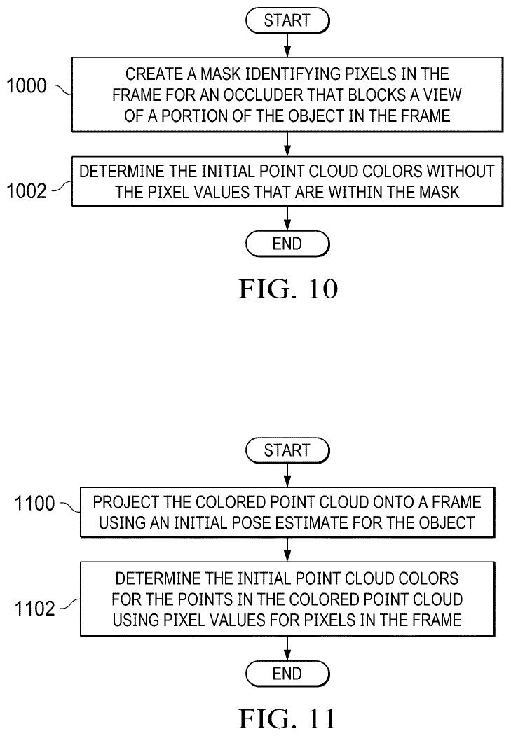

Next in FIG. 10, an illustration of a flowchart of a process for taking into account an occluder of the object is depicted in accordance with an illustrative embodiment. The process in this flowchart is an example of additional operations that can be performed with the operations in FIG. 8.

The process creates a mask identifying pixels in the frame for an occluder that blocks a view of a portion of the object in the frame (operation 1000). The process determines the initial point cloud colors without the pixel values that are within the mask (operation 1002). The process terminates thereafter.

Turning now to FIG. 11, an illustration of a flowchart of a process for estimating the point cloud colors is depicted in accordance with an illustrative embodiment. The process in this figure is an example of an implementation for operation 800 in FIG. 8. In this example, a single frame is used as opposed to using multiple frames to determine colors using all of the frames and pose estimates for those frames.

The process projects the colored point cloud onto a frame using an initial pose estimate for the object (operation 1100). The process determines the initial point cloud colors for the points in the colored point cloud using pixel values for pixels in the frame (operation 1102). The process terminates thereafter.

In the flowchart for this example, a pose for a single frame can be used to determine colors for points in the colored point cloud. For example, this process can be used to obtain an initial pose estimate for the first frame in the video. A colored point cloud can be constructed from the first frame. Afterwards, pose estimation can be performed frame-by-frame in order to obtain a set of coarse pose estimates for the frames in the video.

When performed frame-by-frame, each frame's pose estimation may use the previous frame's pose estimate as an initial pose estimate. For example, this process can be performed via smoothing using a Kalman filter to produce a filtered sequence of pose estimates that removes spurious estimates from the initial sequence of pose estimates. After the initial sequence of pose estimates are obtained and smoothed, the filtered sequence of pose estimates can be used in the dataflow described in FIG. 7.

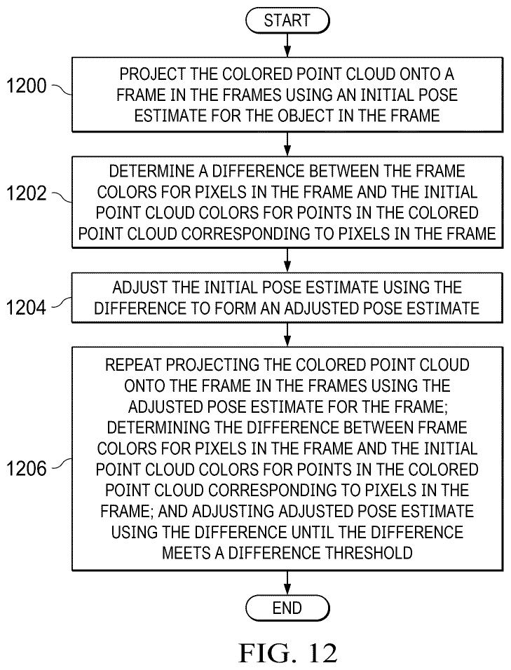

In FIG. 12, an illustration of a flowchart of a process for adjusting initial pose estimates is depicted in accordance with an illustrative embodiment. The process in this flowchart is an example of an implementation for operation 802 in FIG. 8.

The process projects the colored point cloud onto a frame in the frames using an initial pose estimate for the object in the frame (operation 1200). The process determines a difference between the frame colors for pixels in the frame and the initial point cloud colors for points in the colored point cloud corresponding to pixels in the frame (operation 1202). The process adjusts the initial pose estimate using the difference to form an adjusted pose estimate (operation 1204). In operation 1204, the pose estimates can be adjusted using a numerical optimizer with an objective function.

The process repeats projecting the colored point cloud onto the frame in the frames using the adjusted pose estimate for the frame; determining the difference between frame colors for pixels in the frame and the initial point cloud colors for points in the colored point cloud corresponding to pixels in the frame; and adjusting adjusted pose estimate using the difference until the difference meets a difference threshold (operation 1206). The process terminates thereafter. In operation 1206, the difference is used by the numerical optimizer to make adjustments. The difference threshold on example of threshold 228 in FIG. 2. In this example, difference threshold is the amount of error between colors in colored point cloud and the colors identified for pixels corresponding to points in the frames. This threshold can be selected based on the level or accuracy of the pose estimate that is obtained.

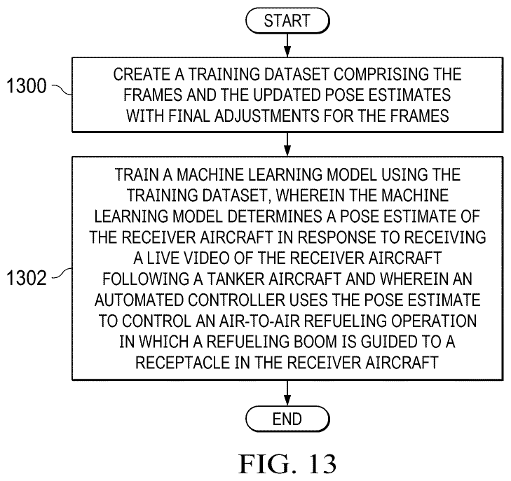

With reference now to FIG. 13, an illustration of a flowchart of a process for training a machine learning model using the adjusted pose estimates is depicted in accordance with an illustrative embodiment. The process in FIG. 13 is an example of additional operations that can be performed with the operations in FIG. 8. In this example, the practical application of adjusting pose estimates is shown.

The process creates a training dataset comprising the frames and the pose estimates with final adjustments for the frames (operation 1300). The process trains a machine learning model using the training dataset, wherein the machine learning model determines a pose of the receiver aircraft in response to receiving a live video of the receiver aircraft following a tanker aircraft and wherein an automated controller uses the pose to control an air-to-air refueling operation in which a refueling boom is guided to a receptacle in the receiver aircraft (operation 1302). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the process in FIG. 13 can be applied to training machine learning models to perform other types of operations or procedures other than refueling a receiver aircraft in an air-to-air refueling operation. For example, the pose estimates can be for containers in a shipyard moved by an automated crane. In this example, a machine learning model can be trained using the video with the pose estimates for containers in those frames to train machine learning model to more accurately generate pose estimates that can be used to control the automated crane to move containers.

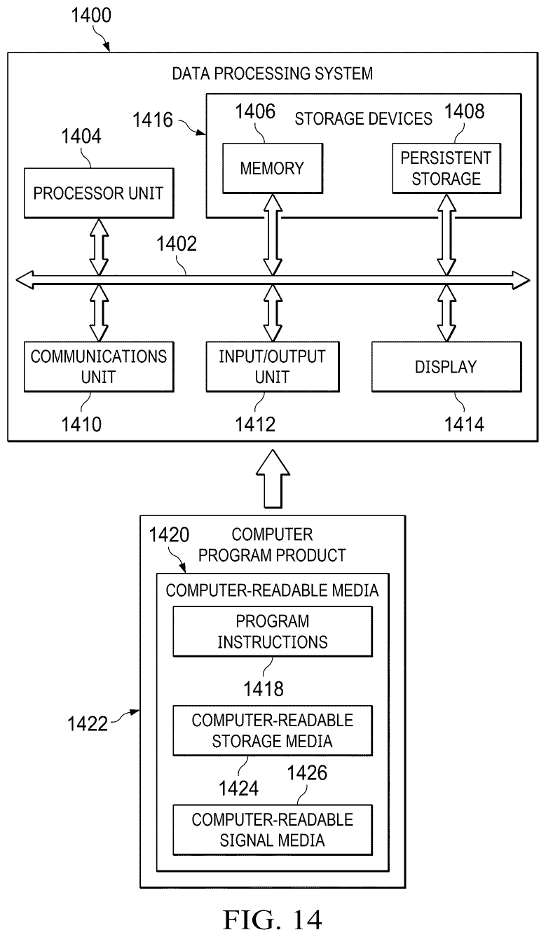

Turning now to FIG. 14, a block diagram of a data processing system is depicted in accordance with an illustrative embodiment. Data processing system 1400 can be used to implement computer 110 and computer 112 in FIG. 1. Data processing system 1400 can be used to implement computer system 212 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, can be, for example, a random-access memory or any other suitable volatile or non-volatile storage device. Persistent storage 1408 may take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs can be located in storage devices 1416, which are in communication with processor unit 1404 through communications framework 1402. The processes of the different embodiments can be performed by processor unit 1404 using computer-implemented instructions, which may be located in a memory, such as memory 1406.

These instructions are referred to as program instructions, computer-usable program instructions, or computer-readable program instructions that can be read and executed by a processor in processor unit 1404. The program instructions in the different embodiments can be embodied on different physical or computer-readable storage media, such as memory 1406 or persistent storage 1408.

Program instructions 1418 are located in a functional form on computer-readable media 1420 that is selectively removable and can be loaded onto or transferred to data processing system 1400 for execution by processor unit 1404. Program instructions 1418 and computer-readable media 1420 form computer program product 1422 in these illustrative examples. In the illustrative example, computer-readable media 1420 is computer-readable storage media 1424.

Computer-readable storage media 1424 is a physical or tangible storage device used to store program instructions 1418 rather than a medium that propagates or transmits program instructions 1418. Computer-readable storage media 1424 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1424, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1418 can be transferred to data processing system 1400 using computer-readable signal media 1426. The computer-readable signal media are signals and can be, for example, a propagated data signal containing program instructions 1418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1420” can be singular or plural. For example, program instructions 1418 can be located in computer-readable media 1420 in the form of a single storage device or system. In another example, program instructions 1418 can be located in computer-readable media 1420 that is distributed in multiple data processing systems. In other words, some instructions in program instructions 1418 can be located in one data processing system while other instructions in program instructions 1418 can be located in one data processing system. For example, a portion of program instructions 1418 can be located in computer-readable media 1420 in a server computer while another portion of program instructions 1418 can be located in computer-readable media 1420 located in a set of client computers.

The different components illustrated for data processing system 1400 are not meant to provide architectural limitations to the manner in which different embodiments can be implemented. In some illustrative examples, one or more of the components may be incorporated in or otherwise form a portion of, another component. For example, memory 1406, or portions thereof, may be incorporated in processor unit 1404 in some illustrative examples. The different illustrative embodiments can be implemented in a data processing system including components in addition to or in place of those illustrated for data processing system 1400. Other components shown in FIG. 14 can be varied from the illustrative examples shown. The different embodiments can be implemented using any hardware device or system capable of running program instructions 1418.

Thus, illustrative examples provide a method, apparatus, system, and computer program product for close estimation. In one illustrative example, pose estimation system comprising a computer system and a pose estimator located in the computer system. The pose estimator is configured to estimate initial point cloud colors for points in a colored point cloud of a surface of an object using frames in a video of the object and initial pose estimates for the object in the frames. The pose estimator is configured to adjust the initial pose estimates using the frames and the colored point cloud to form updated pose estimates. The pose estimator is configured to determine updated point cloud colors for the points in the colored point cloud using the frames in the video and the updated pose estimates. The pose estimator is configured to repeat adjusting the updated pose estimates using the frames and the colored point cloud and determining the updated point cloud colors for the points in the colored point cloud using the frames in the video and the updated pose estimates until the updated pose estimates meet a threshold.

With the use of pose estimations with adjustments performed in the illustrative examples, these posts estimates can be used to train machine learning models to generate processes for use in controlling operations such as air-to-air refueling. In another illustrative example, these pose estimates can be used to model processes.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method for pose estimation, comprising:
estimating, by a number of processor units, initial point cloud colors for points in a colored point cloud of a surface of an object using frames in a video of the object and initial pose estimates for the object in the frames;
adjusting, by the number of processor units, the initial pose estimates to form updated pose estimates using the frames and the colored point cloud;
determining, by the number of processor units, updated point cloud colors for the points in the colored point cloud using the frames in the video and the updated pose estimates; and
repeating, by the number of processor units, adjusting the updated pose estimates using the frames and the colored point cloud and determining the updated point cloud colors for the points in the colored point cloud using the frames in the video and the updated pose estimates until the updated pose estimates meet a threshold.

2. The computer implemented method of claim 1, wherein estimating, by the number of processor units, the initial point cloud colors comprises:
projecting, by the number of processor units, the colored point cloud onto a frame in the frames using an initial pose estimate for the object in the frame;
determining, by the number of processor units, the initial point cloud colors for the points in the colored point cloud using pixel values for pixels in the frame;
repeating, by the number of processor units, projecting the colored point cloud onto the frame using the initial pose estimate for the object in the frame and determining the initial point cloud colors for the points in the colored point cloud using the pixel values for the pixels in the frame for each frame in the frames, wherein the initial point cloud colors are determined for each point in the colored point cloud; and
determining, by the number of processor units, an aggregated color for each point in the colored point cloud using the initial point cloud colors for the points determined from the frames.

3. The computer implemented method of claim 2, wherein the aggregated color for a point in the points is selected from at least one of a mean, a median, or a weighted average of the initial point cloud colors determined for the point.

4. The computer implemented method of claim 2 further comprising:
creating, by the number of processor units, a mask identifying pixels in the frame for an occluder that blocks a view of a portion of the object in the frame; and
determining, by the number of processor units, initial point cloud colors without the pixel values that are within the mask.

5. The computer implemented method of claim 1, wherein estimating, by the number of processor units, the initial point cloud colors comprises:
projecting, by the number of processor units, the colored point cloud onto a frame using an initial pose estimate for the object; and
determining, by the number of processor units, the initial point cloud colors for the points in the colored point cloud using pixel values for pixels in the frame.

6. The computer implemented method of claim 1, wherein adjusting, by the number of processor units, the initial pose estimates comprises:
projecting, by the number of processor units, the colored point cloud onto a frame in the frames using an initial pose estimate for the object in the frame;
determining, by the number of processor units, a difference between frame colors for pixels in the frame and the initial point cloud colors for points in the colored point cloud corresponding to pixels in the frame;
adjusting, by the number of processor units, the initial pose estimate using the difference to form an adjusted pose estimate; and
repeating, by the number of processor units, projecting the colored point cloud onto the frame in the frames using the adjusted pose estimate for the frame; determining the difference between frame colors for pixels in the frame and the initial point cloud colors for points in the colored point cloud corresponding to pixels in the frame; and adjusting adjusted pose estimate using the difference until the difference meets a difference threshold.

7. The computer implemented method of claim 6, wherein the pose estimate is adjusted using a numerical optimizer with an objective function.

8. The computer implemented method of claim 1, wherein the object is a receiver aircraft further comprising:
creating, by the number of processor units, a training dataset comprising the frames and the update pose estimates with final adjustments for the frames; and
training, by the number of processor units, a machine learning model using the training dataset, wherein the machine learning model determines a pose estimate of the receiver aircraft in response to receiving a live video of the receiver aircraft following a tanker aircraft and wherein an automated controller uses the pose estimate to control an air-to-air refueling operation in which a refueling boom is guided to a receptacle in the receiver aircraft.

9. The computer implemented method of claim 1, wherein each of the initial pose estimates comprises a position and orientation for the object.

10. The computer implemented method of claim 1, wherein the object is selected from a group comprising a mobile platform, a stationary platform, a land-based structure, an aquatic-based structure, a space-based structure, an aircraft, a receiver aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

11. A pose estimation system comprising:
a computer system;
a pose estimator located in the computer system, wherein the pose estimator is configured to:
estimate initial point cloud colors for points in a colored point cloud of a surface of an object using frames in a video of the object and initial pose estimates for the object in the frames;
adjust the initial pose estimates using the frames and the colored point cloud to form updated pose estimates;
determine updated point cloud colors for the points in the colored point cloud using the frames in the video and the updated pose estimates; and
repeat adjusting the updated pose estimates using the frames and the colored point cloud and determining the updated point cloud colors for the points in the colored point cloud using the frames in the video and the updated pose estimates until the updated pose estimates meet a threshold.

12. The pose estimation system of claim 11, wherein in estimating the initial point cloud colors, the pose estimator is configured to:
project the colored point cloud onto a frame in the frames using an initial pose estimate for the object in the frame;
determine the initial point cloud colors for the points in the colored point cloud using pixel values for pixels in the frame;
repeat projecting the colored point cloud onto the frame using the initial pose estimate for the object in the frame and determining the initial point cloud colors for the points in the colored point cloud using the pixel values for the pixels in the frame for each frame in the frames, wherein the initial point cloud colors are determined for each point in the colored point cloud; and
determine an aggregated color for each point in the colored point cloud using the initial point cloud colors for the points determined from the frames.

13. The pose estimation system of claim 12, wherein the aggregated color for a point in the points is selected from at least one of a mean, a median, or a weighted average of the initial point cloud colors determined for the point.

14. The pose estimation system of claim 12, wherein the pose estimator is configured to:
create a mask identifying pixels in the frame for an occluder that blocks a view of a portion of the object in the frame; and
determine the initial point cloud colors without the pixel values that are within the mask.

15. The pose estimation system of claim 11, wherein in estimating the initial point cloud colors, the pose estimator is configured to:
project the colored point cloud onto a frame in the frames using an initial pose estimate for the object in the frame; and
determine the point cloud colors for the points in the colored point cloud using pixel values for pixels in the frame.

16. The pose estimation system of claim 11, wherein in adjusting the pose estimates, the pose estimator is configured to:
project the colored point cloud onto a frame in the frames using an initial pose estimate for the object in the frame;
determine a difference between frame colors for pixels in the frame and the initial point cloud colors for points in the colored point cloud corresponding to pixels in the frame;
adjust the initial pose estimate using the difference to form an adjusted pose estimate; and
repeat projecting the colored point cloud onto the frame in the frames using the adjusted pose estimate for the frame; determining the difference between frame colors for pixels in the frame and the initial point cloud colors for points in the colored point cloud corresponding to pixels in the frame; and adjusting adjusted pose estimate using the difference until the difference meets difference threshold.

17. The pose estimation system of claim 16, wherein the pose estimate is adjusted using a numerical optimizer with an objective function.

18. The pose estimation system of claim 11, wherein the object is a receiver aircraft and wherein the pose estimator is configured to:
create a training dataset comprising the frames and the updated pose estimates with final adjustments for the frames; and
train a machine learning model using the training dataset, wherein the machine learning model determines a pose estimate of the receiver aircraft in response to receiving a live video of the receiver aircraft following a tanker aircraft and wherein an automated controller uses the pose estimate to control an air-to-air refueling operation in which a refueling boom is guided to a receptacle in the receiver aircraft.

19. The pose estimation system of claim 11, wherein each of the pose estimates comprises a position and orientation for the object.

20. The pose estimation system of claim 11, wherein the object is selected from a group comprising a mobile platform, a stationary platform, a land-based structure, an aquatic-based structure, a space-based structure, an aircraft, a receiver aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

21. A computer program product for pose estimation, the computer program product comprising:
a set of one or more computer-readable storage media;
program instructions, collectively stored in the set of one or more computer-readable storage media, for causing a processor set to perform the following computer operations:
estimate initial point cloud colors for points in a colored point cloud of a surface of an object using frames in a video of the object and initial pose estimates for the object in the frames;
adjust the initial pose estimates using the frames and the colored point cloud to form updated pose estimates;
determine updated point cloud colors for the points in the colored point cloud using the frames in the video and the updated pose estimates; and
repeat adjusting the updated pose estimates using the frames and the colored point cloud and determining the updated point cloud colors for the points in the colored point cloud using the frames in the video and the updated pose estimates until the updated pose estimates meet a threshold.
